(19) United States
(12) Patent Application Publication
(10) Pub. No.: US 2011/0058209 A1
(43) Pub. Date: Mar. 10, 2011

(54) TRANSMISSION APPARATUS, ELECTRONIC DEVICE AND REMOTE CONTROL SYSTEM OF ELECTRONIC DEVICE

(75) Inventor: Katsumi Nakano, Kitakyushu-shi (JP)

(73) Assignee: SEIKO EPSON CORPORATION, Tokyo (JP)

(21) Appl. No.: 12/873,757

(22) Filed: Sep. 1, 2010

(30) Foreign Application Priority Data
Sep. 4, 2009 (JP) 2009-204440

(51) Int. Cl. G06F 15/02

(52) U.S. Cl. 358/1.14; 358/1.15

(57) ABSTRACT

A transmission apparatus includes a unit which writes command data indicating a content of a processing to be executed by an electronic device into a first data code, a unit which writes an error detection code of the first data code into a bit string of one bit through (N−1) bits in a second data code having a bit number N which is the same as the first data code, a unit which writes an extension code relating to an operation of the electronic device into another bit string formed of the remaining bits, and a unit which transmits a remote control signal in which the first data code and the second data code are combined to the electronic device.

### CROSS REFERENCES TO RELATED APPLICATIONS

The present invention contains subject matter related to Japanese Patent Application No. 2009-204440 filed in the Japanese Patent Office on Sep. 4, 2009, the entire contents of which are incorporated herein by reference.

### BACKGROUND

1. Technical Field

The present invention relates to a technique for remote control of an electronic device such as a printer by using a remote control signal.

2. Related Art

In order to remotely control an electronic device such as a printer, a remote control system using a remote control signal has been proposed. In the remote control system, a remote control unit (corresponding to “transmission apparatus” in the invention) which transmits a remote control signal is attached to an electronic device. Further, in the remote control system, a receiving apparatus built in the electronic device receives a remote control signal output from the remote control unit so that the electronic device executes a processing corresponding to command data included in the remote control signal.

As such a remote control signal, a signal of an NEC (registered trademark) format is used in many cases, for example. The remote control signal includes a leader code, a custom code (16 bits), a data code (8 bits) and a logically inverted value (8 bits) of the data code in this order (see, FIG. 3A). The custom code among these codes is managed by NEC Corporation and can be acquired by applying to NEC Corporation. One custom code is assigned to one company in principle. Further, command data and the like to the electronic device are written into the data code and are transmitted. It is to be noted that the logically inverted value (8 bits) of the data code is a value for checking the above command data.

The remote control technique has been originally developed to remotely control an electronic device in which one receiving apparatus is built with one transmission apparatus. Therefore, it is assumed that the remote control technique is used in a state where the transmission apparatus and the receiving apparatus have one to one correspondence to each other. However, there have been disadvantages in some case in which a case where a plurality of electronic devices manufactured by the same manufacturer are simultaneously used is considered. For example, when a plurality of printers manufactured by the same manufacturer are installed on the same floor in an office, a following problem arises. That is, even if a remote control unit attached to the printer is operated for operating a desired printer, a remote control signal output from the remote control unit is received by other printers installed on the floor and recognized as an effective signal. This causes a problem that these printers possibly operate differently from an intension of an operator who has operated the remote control unit.

In order to overcome such a problem, if a plurality of custom codes can be acquired, individual custom codes can be assigned to each of the printers on the same floor. However, one custom code is limited to be assigned to one company in principle as described above. Therefore, the above countermeasure cannot be employed. Then, as described in JP-A-2003-163979 (FIG. 1), it is considered that a data code (corresponding to “second data code” in the invention) is used in a usage purpose which is different from an original usage purpose thereof. A logically inverted value (8 bits) of a data code is determined to be written into the data code on the NEC format. That is to say, individual identification codes are assigned to each of the printers on the same floor, and an identification code for identifying a printer is written into the data code. Then, the remote control signal is transmitted so that only printer having the identification code can be operated.

What identification codes are assigned to each electronic device as described above is a very reasonable solution method. However, it cannot be checked whether or not command data included in a remote control signal received by an electronic device is appropriate data. This causes another problem that electronic devices cannot be stably, remotely controlled with high reliability. Further, there is also a possibility that an identification code included in the remote control signal is rewritten due to noise generated from fluorescent lights or other electronic devices in the office. Therefore, means for checking the identification code is also desired in order to enhance the reliability.

### SUMMARY

An advantage of some aspects of the invention is to provide a technique for stable remote control of an electronic device with high reliability through solving at least one of the issues mentioned above.

A transmission apparatus according to an aspect of the invention writes command data indicating a content of a processing to be executed by an electronic device into a first data code, writes an error detection code of the first data code into a bit string of one bit through (N−1) bits in a second data code having a bit number N which is the same as the first data code, writes an extension code relating to an operation of the electronic device into another bit string formed of the remaining bits, and transmits a remote control signal in which the first data code and the second data code are combined to the electronic device so as to control the operation of the electronic device.

An electronic device according to another aspect of the invention includes: a receiving unit which receives a remote control signal in which a first data code into which command data is written and a second data code of which bit number is N which is the same as the first data code and in which an error detection code of the first data code is written into a bit string of one bit through (N−1) bits and an extension code relating to an operation of the electronic device is written into another bit string formed of the remaining bits are combined; a processing unit which executes a processing corresponding to the first data code included in the remote control signal received by the receiving unit; and a controller which controls an operation of a processing corresponding to the first data code in response to the extension code in the remote control signal received by the receiving unit.

A remote control system of the electronic device according to still another aspect of the invention includes a transmission apparatus which transmits a remote control signal in which a first data code into which command data is written and a second data code of which bit number is N which is the same as the first data code are combined, and an electronic device which has a receiving unit which receives the remote control signal transmitted by the transmission apparatus and is capable of executing a processing corresponding to the first data code included in the remote control signal received by the receiving unit. In the remote control system of the electronic device, the transmission apparatus writes an error detection code of the first data code into a bit string of one bit through (N−1) bits in the second data code and an extension code relating to an operation of the electronic device into another bit string formed of the remaining bits in the second data code, and the electronic device compares an error detection code of the first data code included in the received remote control signal with the error detection code which has been included in the received remote control signal so as to judge whether an error in the first data code included in the received remote control signal is present and controls an operation of a processing corresponding to the first data code in response to the extension code included in the received remote control signal.

In the aspects of the invention which are configured as described above (transmission apparatus, electronic device, and remote control system of the electronic device), a remote control signal in which a first data code into which command data is written and a second data code of which bit number is N which is the same as the first data code are combined is used. The electronic device which has received the remote control signal can execute a processing corresponding to the command data (first data code). In addition, an extension code is included in the remote control signal and an operation of the processing corresponding to the first data code can be controlled in response to the extension code. Accordingly, even when a remote control signal output from one transmission apparatus is received by a plurality of electronic devices, each of the electronic devices can be appropriately, remotely controlled. For example, the extension code can be used as the above described identification code. That is, when the electronic device receives the remote control signal, and if the extension code (identification code) does not correspond to the electronic device, a processing corresponding to the first data code by the electronic device will be suppressed. Further, since the error detection code of the first data code is included in the second data code in addition to the above described extension code, even when the first data code changes caused by influence of disturbances such as noise, an error in the first data code can be detected. Accordingly, the electronic device can be stably, remotely controlled with high reliability.

### BRIEF DESCRIPTION OF THE DRAWINGS

The invention will be described with reference to the accompanying drawings, wherein like numbers reference like elements.

FIG. 1 is a perspective view illustrating an embodiment of a remote control system of an electronic device according to the invention.

FIG. 2 is a block diagram illustrating an electric configuration of a photo printer and an infrared remote control unit in FIG. 1.

FIGS. 3A and 3B are diagrams illustrating a format of a remote control signal used in the remote control system in FIG. 1.

FIG. 4 is a flowchart illustrating a data transmission processing by infrared remote control.

FIG. 5 is a flowchart illustrating a receiving processing of the photo printer which has received a remote control signal.

FIGS. 6A and 6B are schematic diagrams illustrating remote control modes of the photo printer by infrared remote control.

FIGS. 7A and 7B are diagrams illustrating a format of the remote control signal used in another embodiment of the invention.

### DESCRIPTION OF EXEMPLARY EMBODIMENTS

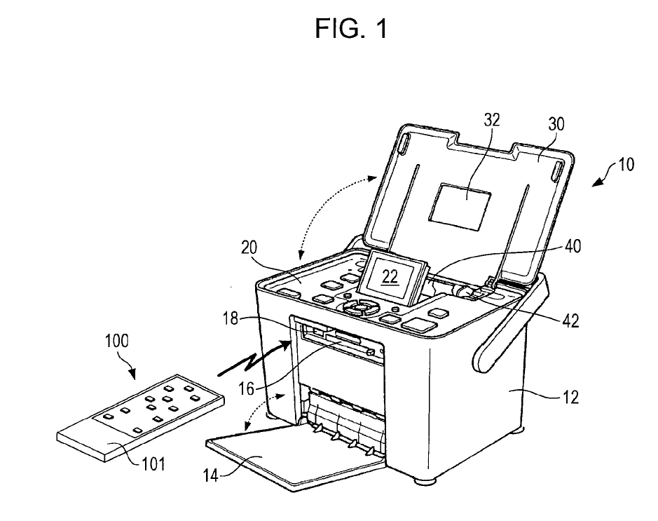

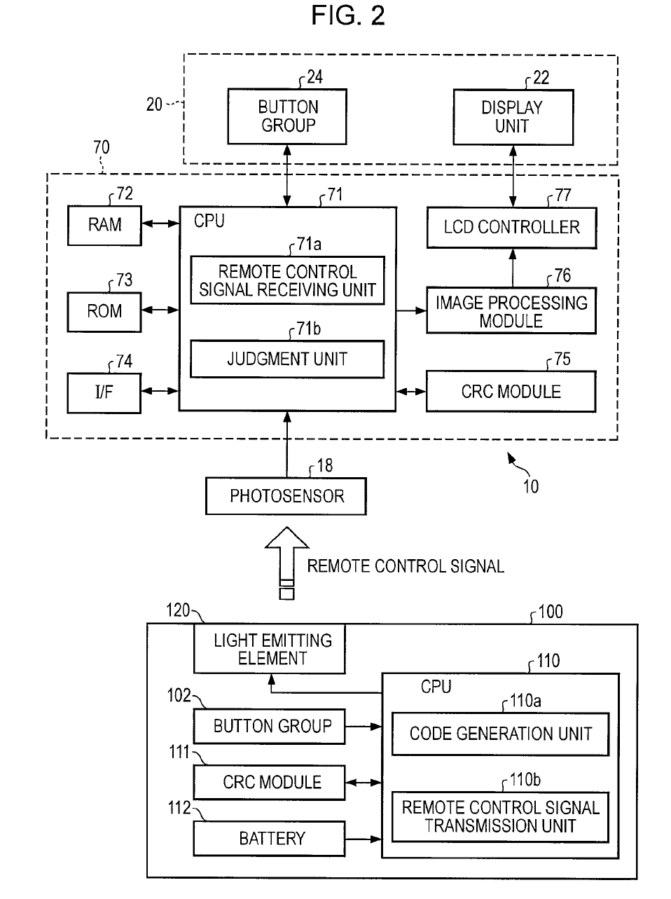

FIG. 1 is a perspective view illustrating a remote control system of a photo printer which includes a photo printer as an embodiment of an electronic device according to the invention and an infrared remote control unit as an embodiment of a transmission apparatus according to the invention. FIG. 2 is a block diagram illustrating an electric configuration of the photo printer and the infrared remote control unit in FIG. 1. In a photo printer 10, a print mechanism is built inside a printer main body 12. The photo printer 10 executes printing onto a sheet in accordance with an operation instruction from a controller 70 (see, FIG. 2) which controls the entire photo printer 10. Then, the printed sheet is discharged to a front side of the printer main body 12. On the other hand, an infrared remote control unit 100 generates a remote control signal as a control signal for controlling the photo printer 10 in accordance with an input operation by a user to transmit the remote control signal to the photo printer 10. Then, the photo printer 10 which has received the remote control signal executes a processing in accordance with command data (first data code) included in the remote control signal. In such a manner, the photo printer 10 shown in FIG. 1 can be remotely controlled by the infrared remote control unit 100. The photo printer 10 and the infrared remote control unit 100 constitute a “remote control system of an electronic device” according to the invention. The controller 70 corresponds to a “controller” according to the invention and the print mechanism corresponds to a “processing unit” according to the invention. Hereinafter, a configuration of the infrared remote control unit 100 and that of the photo printer 10 are described separately. Then, a remote control operation by the infrared remote control unit 100 is described.

In the infrared remote control unit 100, as shown in FIG. 1, a plurality of buttons 102 are arranged on a remote control main body 101. A user can remotely control a specific photo printer 10 through the buttons 102 or collectively remotely control a plurality of photo printers 10 installed on the same floor in the office through the buttons 102. As shown in FIG. 2, a CPU 110, a CRC module 111 and a battery 112 are provided inside the remote control main body 101. The CPU 110 generates a remote control signal to the photo printer 10 to be controlled based on an input operation by a user. In order to generate the remote control signal, the CPU 110 executes a program stored in a ROM (not shown), and functions as a code generation unit 110a which makes a code to be included in the remote control signal and as a remote control signal transmission unit 110b which transmits the remote control signal. Further, the CRC module 111 is a module which generates check data of a specified bit number by processing a first data code included in the remote control signal using a formula of generation polynomial. In the embodiment, the CRC module 111 generates a Cyclic Redundancy Check (CRC) formed of a 4-bit string by using CRC4. Details of the remote control signal and the CRC used in the embodiment, the code generation and the like will be described later.

A remote control signal generated by the code generation unit 110a of the CPU 110 is given to the remote control signal transmission unit 110b. The remote control signal transmission unit 110b drives a light emitting element 120 based on the remote control signal to transmit the remote control signal to the photo printer 10.

Next, a configuration of the photo printer 10 to be remotely controlled by the infrared remote control unit 100 which is configured as described above is described. As shown in FIG. 1, a front door 14 is attached to a front face of the printer main body 12 in such a manner as to be freely opened and closed. The front door 14 is a lid for opening and closing a front face of the printer main body 12. When the front face is in the opened sate, the front door 14 functions as a sheet discharge tray for receiving a sheet discharged from a print mechanism (not shown) provided inside the printer main body 12. Further, a user can use various types of memory card slots 16 provided on the front face of the printer main body 12 in the opened state. That is, the user can insert a memory card in which an image file to be printed is stored in any one of the memory card slots 16 in this state. An external storage medium storing image file data is not limited to the memory card and other media such as a USB memory and a disk medium may be used. Further, electronic devices such as a digital camera and a mobile phone in which an image has been stored may be used by making such electronic devices function as an external storage medium by connecting them to the photo printer 10 through communication using a cable or infrared rays.

Further, a photosensor (corresponding to “receiving unit”) 18 is provided at the side of the memory card slots 16. The photosensor 18 receives a remote control signal transmitted from the infrared remote control unit 100 based on an input operation by a user and outputs the received infrared rays as the remote control signal to a remote control signal receiving unit 71a which will be described later. A photosensor of Infrared Data Association (IrDA) standards, for example, is provided in the vicinity of the photosensor 18. The photosensor of IrDA standards is communicable with the electronic devices such as a digital camera and a mobile phone by using infrared rays.

Further, an operation panel 20 is provided on an upper face of the printer main body 12. A cover 30 is attached to one back side on an upper face of the printer main body 12 in such a manner as to be freely opened and closed. The cover 30 is a resin plate molded to such a size that the cover 30 can cover the upper face of the printer main body 12. When the cover 30 is in the opened state, an upper surface of the operation panel 20 is exposed to the outside (see, FIG. 1). On the other hand, when the cover 30 is in the closed state, the cover 30 covers the entire operation panel 20.

The operation panel 20 includes a display unit 22 and a button group 24. The display unit 22 is formed of an LCD display which displays characters, graphics, symbols or the like, for example. The button group 24 is arranged around the display unit 22. Further, the button group 24 includes a power supply button, a menu button, a cancel button, a print button, a storage button, arrow buttons, an OK button, a display switching button, a left guide selection button, a right guide selection button, a sheet discharge tray open button, and the like. The power supply button is a button for turning ON/OFF a power supply. The menu button is a button for calling a main menu screen. The cancel button is a button for cancelling an operation halfway or stopping printing onto a sheet halfway. The print button is a button for giving instructions to execute printing onto a sheet. The storage button is a button for storing an edited image or the like in a memory card inserted to any one of the memory card slots 16. The arrow buttons are formed of left, right, up and down arrow buttons which are operated for selecting a desired option from a plurality of options displayed on the display unit 22 or for moving a cursor. The OK button is arranged at a center of the arrow buttons of left, right, up and down and is a button for giving instructions to determine an option being selected by the arrow buttons. The display switching button is a button for switching a screen display on the display unit 22. The left guide selection button is a button for selecting a left guide displayed on the display unit 22. The right guide selection button is a button for selecting a right guide displayed on the display unit 22. The sheet discharge tray open button is a button for opening the front door 14 having a function as a sheet discharge tray.

A window 32 of which size is the same as the display unit 22 is provided on the cover 30 in order to check a content displayed on the display unit 22. That is to say, when the cover 30 is in the closed state, a user can check a content displayed on the display unit 22 through the window 32. On the other hand, when the cover 30 is in the opened state, the display unit 22 can be adjusted at a preferred angle for a user as shown in FIG. 1.

When the cover 30 is in the opened state in such a manner, the cover 30 is held in a state where the cover 30 is inclined backward with respect to the operation panel 20 and is used as a tray for supplying a sheet to the print mechanism. Further, a sheet feeding opening 40 of the print mechanism and a pair of sheet guides 42 are provided on the back side of the operation panel 20. The pair of sheet guides 42 are slidably operated in the horizontal direction such that the guide width is fitted to a sheet width. The sheet is fed to the print mechanism through the sheet feeding opening 40 while parts of the print mechanism are controlled by the controller 70 so that printing is executed.

As shown in FIG. 2, the controller 70 is configured as a micro processor in which a CPU 71 is provided at a center. The controller 70 includes a ROM 73, a RAM 72, an interface (I/F) 74, a CRC module 75 and the like. The ROM 73 has stored various types of processing programs, data, programs, tables and the like. The RAM 72 temporarily stores data. The interface (I/F) 74 makes it possible to communicate with the print mechanism, the memory card slots 16 and the like. Further, the controller 70 stores an edited image in the memory card and also outputs a control signal to a printing head (not shown) of the print mechanism and a control signal to the display unit 22 of the operation panel 20.

In addition, an image processing module 76 is provided on the controller 70. The image processing module 76 performs a required image processing on image data in order to display an image based on the image data provided from an external storage medium such as a memory card through the interface 74 on the display unit 22. The image processing module 76 also has a function of generating image data corresponding to images inherent to a printer such as a menu screen to be displayed on the display unit 22, partial writing data corresponding to a partial image inserted by replacing a part of a base image displayed on the display unit 22, such as an icon, and the like.

RGB image data output from the image processing module 76 is given to an LCD controller 77 for display controlling of the display unit 22. The LCD controller 77 displays an image based on the image data read from a video RAM (VRAM) (not shown) on the display unit 22. Hereinafter, a pixel number of the display unit 22 formed of the LCD display is 800 dots×480 dots of Wide Video Graphics Array (WVGA). To be more specific, pixel data for 800 dots constitutes one line of image data, and line data including 480 lines constitutes one image. Accordingly, RGB image data of an image corresponding to one screen of the display unit 22 having the size of 800 dots×480 dots is input from the image processing module 76 to the LCD controller 77. Note that as color definition of the image data for each pixel, each pixel is represented by 8 bits for each color element, and then a full color display of each pixel can be realized by a data size of 24 bits (3 bytes) in total.

Further, the CPU 71 functions as a remote control signal receiving unit 71a and a judgment unit 71b by executing a program stored in the ROM 73. The remote control signal receiving unit 71a receives a remote control signal which has been transmitted from the infrared remote control unit 100 using infrared rays and has subsequently been received and output by the photosensor 18. Then, the remote control signal receiving unit 71a decodes the received remote control signal to acquire various types of data codes included in the remote control signal. Further, a part of these data codes is given to the CRC module 75 to generate a CRC. The judgment unit 71b performs a predetermined judgment processing based on the data codes and the CRC output from the CRC module 75. If the remote control signal received by the remote control signal receiving unit 71a is judged to be appropriate in the predetermined judgment processing, each part of the photo printer 10 is controlled based on the received data code. The predetermined judgment processing will be described in detail below.

Next, a format of a remote control signal, which is used in the infrared remote control unit 100 and the photo printer 10 configured as described above, is described. Thereafter, operations of the infrared remote control unit 100 and the photo printer 10 are illustrated.

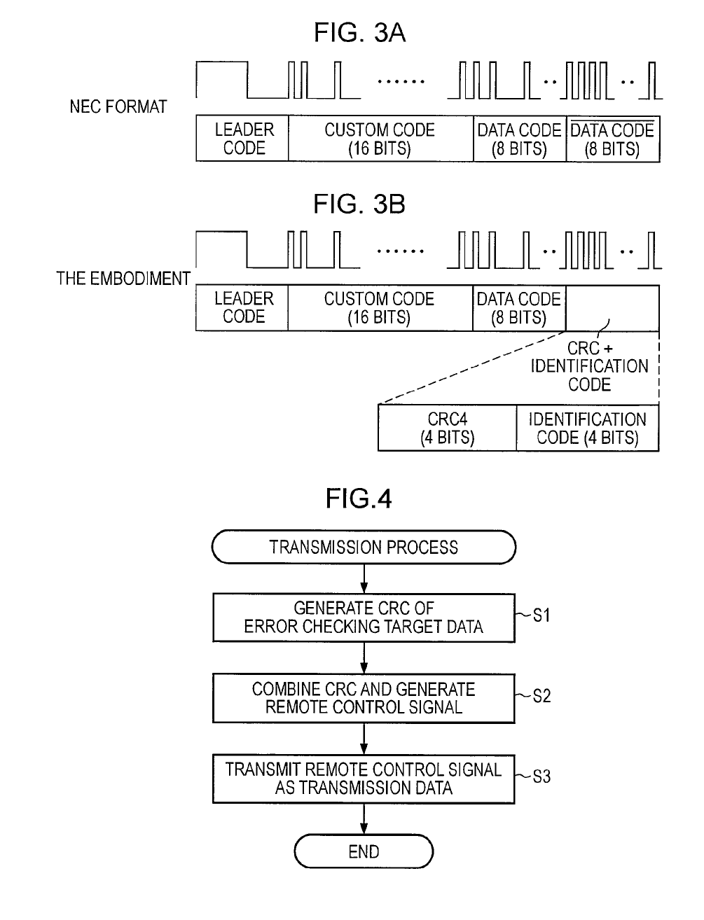

FIGS. 3A and 3B are diagrams illustrating a format of a remote control signal. As shown in FIG. 3B, a unique format which is formed by changing a part of a so-called NEC format is employed in the embodiment. In the format of the remote control signal used in the embodiment, the format starts from a leader code, followed by a custom code of 16 bits and a first data code of 8 bits as in the NEC format. In the leader code among these codes, ON state continues for a period of 9 ms, and then, OFF state continues for a period of 4.5 ms. The waveform of the leader code is largely different from those of the custom code and the first data code. Therefore, the leader code and the custom code can be obviously identified with ease. Further, the custom code is a code for identifying a manufacturer which manufactures electronic devices including the photo printer 10. One custom code is set to one company in principle as described above. The first data code following the custom code is a command data transmitted to the electronic device from the infrared remote control unit 100 so as to make the electronic device execute a desired operation.

A second data code of 8 bits following the first data code (command data) has a logically inverted value of the first data code (command data) in the NEC format. This is to prevent a malfunction in the electronic device which receives a remote control signal so as to be remotely controlled. In comparison with the second data code in the NEC format, in the embodiment, a 4-bit string of a first half among 8 bits constituting the second data code is a CRC as an example of an “error detection code” according to the invention. Further, in the embodiment, a 4-bit string of a latter half is an identification code as an example of an “extension code” according to the invention. The CRC is a value calculated by giving the first data code to the CRC module 111 and functions as error check data. Further, the identification code is obtained by distributing 16 kinds of IDs by the manufacturer or the user. In the embodiment, individual IDs can be set to each of 15 kinds of photo printers 10. Alternatively, an ID to collectively operate the 15 kinds of photo printers 10 can be set. That is to say, IDs for individually operating each photo printer may be set at a stage where the photo printers 10 are manufactured and shipped. Alternatively, after the shipment, the user may operate the button group 24 of the operation panel 20 or operate a computer connected to the photo printers 10 to set IDs. For example, in order to individually operate or collectively operate three photo printers 10 which will be described later, “0001”, “0010” and “0011” may be set to the three photo printers 10 as the identification codes. Alternatively, as the identification code for collectively operating all the photo printers 10, “1111” may be set to the three photo printers 10. It is to be noted that the format in the embodiment is configured to be the same as the NEC format other than the second data code.

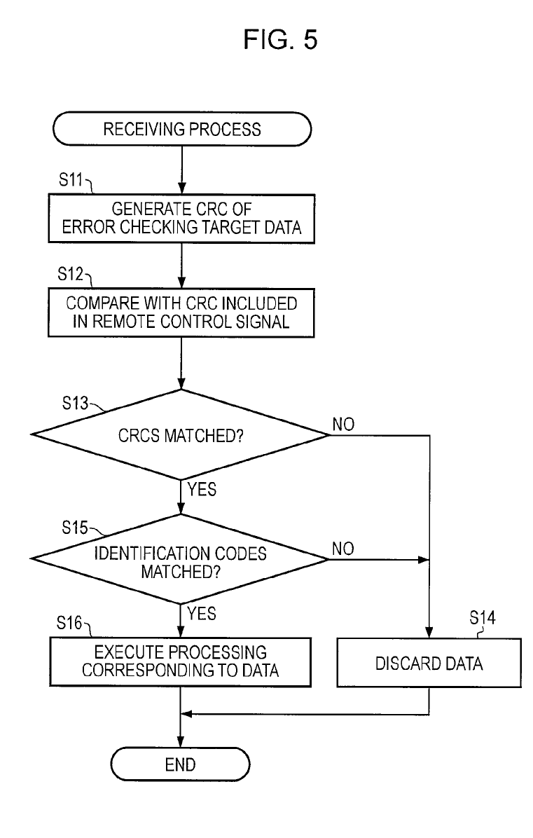

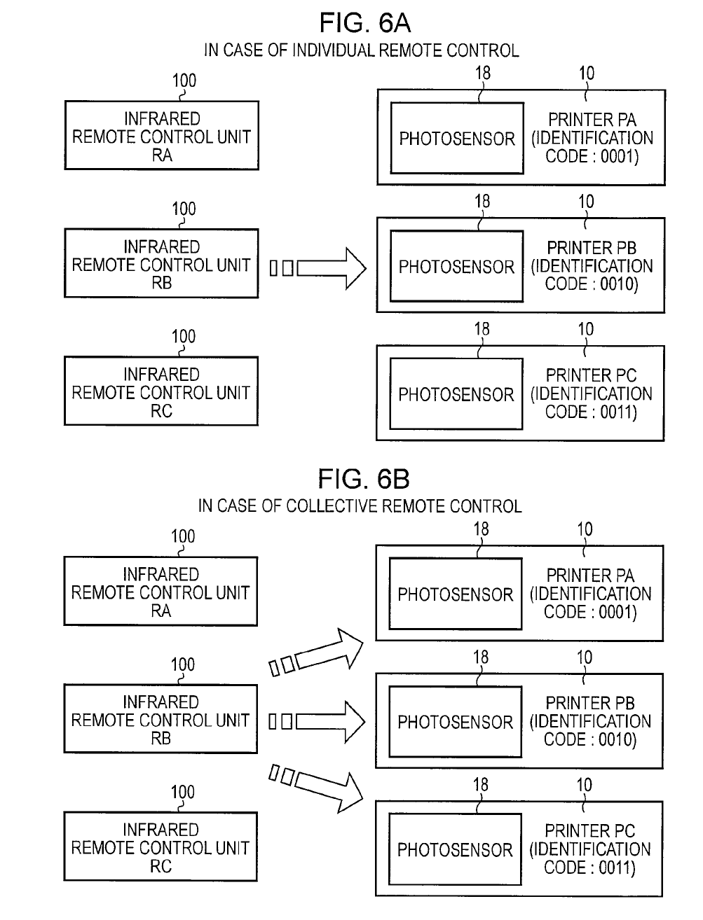

FIG. 4 is a flowchart illustrating a data transmission processing by the infrared remote control unit. FIG. 5 is a flowchart illustrating a receiving process of the photo printer which has received a remote control signal. FIGS. 6A and 6B are schematic diagrams illustrating remote control modes of the photo printer by the infrared remote control unit. Hereinafter, the remote control operation of the photo printer 10 is described with reference to these drawings.

When the user remotely controls the photo printer 10, the user operates various types of buttons 102 of the infrared remote control unit 100. At this time, in the infrared remote control unit 100, the code generation unit 110a generates command data which indicates a processing content desired by the user in accordance with the operation of the buttons. Further, the code generation unit 110a gives the generated command data to the CRC module 111. The CRC module 111 which has received the command data inputs the command data of 8 bits as target data to be redundancy-checked and generates a value of 4 bits obtained by calculating the data with the CRC4 polynomial (thus obtained value is referred to as “CRC” in the specification) as an error detection code (step S1 (hereinafter called as Sn, n=1, 2, 3 and so on)).

The code generation unit 110a sets the command data as a first data code following the leader code and the custom code, and generates a remote control signal by combining a second data code formed of the CRC of 4 bits and the identification code of 4 bits and the first data code (S2). Note that the identification code of 4 bits is set as follows. For example, as shown in FIGS. 6A and 6B, an individual identification code is given to each of the infrared remote control units 100 in order to individually, remotely control three photo printers 10. Further, an identification code “1111” can be set in order to collectively, remotely control the photo printers 10 with one infrared remote control unit 100. The three photo printers 10 and the infrared remote control units 100 are referred to as follows when referring to FIG. 6 for convenience of understanding and description. That is, the three photo printers 10 are referred to as a “printer PA”, a “printer PB” and a “printer PC.” Infrared remote control units 100 attached to each of the printer PA (identification code: 0001), the printer PB (identification code: 0010), and the printer PC (identification code: 0011) are referred to as an “infrared remote control unit RA”, an “infrared remote control unit RB”, and an “infrared remote control unit RC”. That is to say, when the printer PB is individually, remotely controlled with the infrared remote control unit RB, the code generation unit 110a sets “0010” as the identification code in the remote control signal. On the other hand, all of the printers PA, PB, PC are collectively, remotely controlled with the infrared remote control unit RB, the code generation unit 110a sets “1111” as the identification code in the remote control signal.

When the generation of the remote control signal is completed in such a manner, the remote control signal transmission unit 110b drives the light emitting element 120 based on the remote control signal to transmit the remote control signal to the photo printers 10 (S3).

In each of the photo printers 10, when the photosensor 18 receives the remote control signal, a receiving process shown in FIG. 5 is executed. In S11, the remote control signal received by the remote control signal receiving unit 71a is decoded so that the command data (first data code) included in the remote control signal is input to the CRC module 75 as target data to be redundancy-checked. In the CRC module 75, the command data is calculated with the CRC4 polynomial and the CRC of 4 bits obtained by the calculation is generated as an error detection code, in the same manner as the CRC module 111.

The CRC is given to the judgment unit 71b and is compared with the CRC included in the remote control signal by the judgment unit 71b (S12). Then, if the CRC generated in the infrared remote control unit 100 does not match the CRC generated in the photo printer 10 (“NO” in S13), data included in the received remote control signal is discarded (S14). In other words, the judgment unit does not perform any processing and awaits a next remote control signal. On the other hand, if the judgment unit 71b judges “YES” in S13, the judgment unit 71b further judges whether the received remote control signal is intended for the photo printer 10 based on the identification code in the remote control signal (S15). Then, if the judgment unit 71b judges “NO” in S15, the process proceeds to S14 to discard the data. On the other hand, if the judgment unit 71b judges “YES” in S15, the photo printer 10 executes a processing corresponding to the first data code in the remote control signal (S16).

For example, as shown in FIG. 6A, when the remote control signal is transmitted from the infrared remote control unit RB to make the printer PB execute a printing operation, “0010” is set as the identification code (4 bits of the latter half of the second data code) of the remote control signal. The judgment units 71b in the printers PA, PC, which have received the remote control signal, confirm mismatching of the identification codes to discard the data (S14). On the other hand, the judgment unit 71b in the printer PB confirms matching of the identification codes. Upon the confirmation, the CPU 71 controls each part of the printer PB and the printing operation is executed (S16).

As shown in FIG. 6B, when the remote control signal is transmitted from the infrared remote control unit RB so as to make all the printers PA, PB, PC collectively execute the printing operations, “1111” is set as the identification code (4 bits of the latter half of the second data code) of the remote control signal. The judgment units 71b in each of the printers PA, PB, PC, which have received the remote control signal, confirm that the identification code in the remote control signal matches the identification code “1111” at the time of the collective remote control. Upon the confirmation, printing operations are executed in each of the printers PA, PB, PC (S16).

As described above, according to the embodiment, a remote control signal in which the first data code of 8 bits into which the command data is written and the second data code of 8 bits are combined is used. At this time, the identification code (extension code) is written into the 4-bit string of the latter half of the second data code, thereby being capable of controlling an operation of a processing corresponding to the first data code in response to the identification code. Accordingly, for example, as shown in FIG. 6A, the remote control signal transmitted from the infrared remote control unit RB is received not only by the printer PB but also by other printers PA, PC. However, when the identification code is not an identification code indicating the printers PA, PC or an identification code indicating collective remote control, a processing corresponding to the first data code can be suppressed. Further, the CRC is written into the second data code as an error detection code of the first data code (command data) in addition to the above identification code. Therefore, even when the first data code changes due to influence of disturbances such as noise, an error in the first data code can be detected. Therefore, the photo printer 10 can be stably, remotely controlled with high reliability.

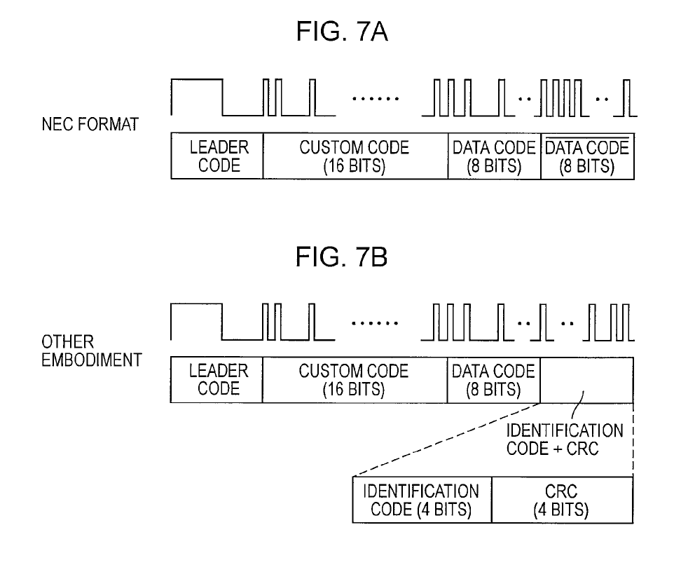

In the above embodiment, the CRC of the first data code (command data) as a target of error check is calculated. However, for example, a CRC of a data code obtained by combining the first data code and the identification code may be calculated for use as an error detection code. At this time, as shown in FIG. 7B, an identification code is written into a 4-bit string of a first half of the second data code while the first data code and the identification code are set as the target of error check. In this case, a newly calculated CRC of the data code obtained by combining the first data code and the identification code included in the received remote control signal and the CRC included in the received remote control signal are compared with each other. With the comparison, it can be judged whether an error in the first data code and the identification code included in the received remote control signal is present. In this case, even when the identification code changes due to influence of disturbances such as noise, an error can be detected with certainty and reliability thereof can be further improved.

The invention is not limited to the above embodiment, and various changes can be made as long as the changes are not deviated from the spirit and scope of the invention. For example, in the embodiment, cases where three printers PA, PB, PC are collectively, remotely controlled and individually, remotely controlled are described. However, since the identification code formed of a 4-bit string is employed in the embodiment, 15 or less printers 10 can be collectively, remotely controlled or individually, remotely controlled.

In the above embodiment, the CRC of 4 bits obtained by calculation with the CRC4 polynomial is used as an error detection code. However, the error detection code is not limited thereto and a CRC of a bit string of one bit through (N−1) bits in the second data code formed of a bit string of N bits can be used.

Further, in the above embodiment, the identification code indicating the ID of the printer 10 is used as an “extension code” according to the invention. However, data codes arbitrarily set by the user or the like may be used as the extension code. Further, the bit number of the extension code is also not limited to “4 bits”, and the bit number of the extension code may be set in accordance with the bit number of the error detection code.

Further, in the above embodiment, a case where the photo printer 10 is remotely controlled as an “electronic device” according to the invention is described. However, the application of the invention is not limited to the photo printer 10 and the invention can be applied to any electronic devices which can be remotely controlled by the remote control signal.

What is claimed is:

1. A transmission apparatus comprising:
a unit which writes command data indicating a content of a processing to be executed by an electronic device into a first data code;
a unit which writes an error detection code of the first data code into a bit string of one bit through (N−1) bits in a second data code having a bit number N which is the same as the first data code;
a unit which writes an extension code relating to an operation of the electronic device into another bit string formed of the remaining bits; and
a unit which transmits a remote control signal in which the first data code and the second data code are combined to the electronic device.

2. The transmission apparatus according to claim 1,
wherein the error detection code is a code for detecting an error of a code obtained by combining the first data code and the extension code.

3. The transmission apparatus according to claim 1,
wherein the error detection code is a cyclic redundancy check.

4. An electronic device comprising;
a receiving unit which receives a remote control signal in which a first data code into which command data is written and a second data code of which bit number is N which is the same as the first data code and in which an error detection code of the first data code is written into a bit string of one bit through (N−1) bits and an extension code relating to an operation of the electronic device is written into another bit string formed of the remaining bits are combined;
a processing unit which executes a processing corresponding to the first data code included in the remote control signal received by the receiving unit; and
a controller which controls an operation of a processing corresponding to the first data code in response to the extension code in the remote control signal received by the receiving unit.

5. The electronic device according to claim 4,
wherein the error detection code is a code for detecting an error of a code obtained by combining the first data code and the extension code.

6. The electronic device according to claim 4,
wherein the error detection code is a cyclic redundancy check.

7. A remote control system of an electronic device comprising:
a transmission apparatus which transmits a remote control signal in which a first data code into which command data is written and a second data code of which bit number is N which is the same as the first data code are combined; and
an electronic device which has a receiving unit which receives the remote control signal transmitted from the transmission apparatus and is capable of executing a processing corresponding to the first data code included in the remote control signal received by the receiving unit,
wherein the transmission apparatus writes an error detection code of the first data code into a bit string of one bit through (N−1) bits in the second data code and an extension code relating to an operation of the electronic device into another bit string formed of the remaining bits in the second data code, and
the electronic device compares an error detection code of the first data code included in the received remote control signal with the error detection code which has been included in the received remote control signal so as to judge whether an error in the first data code included in the received remote control signal is present and controls an operation of a processing corresponding to the first data code in response to the extension code included in the received remote control signal.

8. The remote control system of the electronic device according to claim 7,
wherein the error detection code is a code for detecting an error of a code obtained by combining the first data code and the extension code.

9. The remote control system of the electronic device according to claim 7,
wherein the error detection code is a cyclic redundancy check.
